(19) United States
(12) Patent Application Publication
(10) Pub. No.: US 2022/0197878 A1
(43) Pub. Date: Jun. 23, 2022

(54) Compressed Read and Write Operations via Deduplication

(71) Applicant: Advanced Micro Devices, Inc., Santa Clara, CA (US)

(72) Inventors: Matthäus G. Chajdas, Munich (DE); Christopher J. Brennan, Boxborough, MA (US)

(21) Appl. No.: 17/129,588

(22) Filed: Dec. 21, 2020

(51) Int. Cl. G06F 16/215; G06F 9/50

(52) U.S. Cl. CPC G06F 16/215; G06F 9/5027

(57) ABSTRACT

Systems, apparatuses, and methods for implementing a collapsed stack are disclosed. A parallel processor includes a plurality of compute units for executing wavefronts of a given application. Each compute unit includes multiple single-instruction, multiple-data (SIMD) units. When the work-items executing on the execution lanes of a SIMD unit are writing data values to a stack, many of the data values are repeated. In these cases, when the lanes are pushing duplicate data values to the stack, a control unit deduplicates the duplicate data values and stores the deduplicated data values. The control unit then generates a control word that maps the deduplicated data values to execution lanes and stores the control word in association with the stored data values. When the stored data values are restored, the control word is used to determine which lanes receive which values of the stored data values.

### BACKGROUND

### Description of the Related Art

Graphics processing units (GPUs) and other multithreaded processing units typically include multiple processing elements (which are also referred to as processor cores or compute units) that concurrently execute multiple instances of a single program on multiple data sets. The instances are referred to as threads or work-items, and groups of threads or work-items are created (or spawned) and then dispatched to each processing element in a multi-threaded processing unit. The processing unit can include hundreds of processing elements so that thousands of threads are concurrently executing programs in the processing unit. In a multithreaded GPU, the threads execute different instances of a kernel to perform calculations in parallel.

In many applications executed by a GPU, a sequence of work-items are processed so as to output a final result. In one implementation, each processing element executes a respective instantiation of a particular work-item to process incoming data. A work-item is one of a collection of parallel executions of a kernel invoked on a compute unit. A work-item is distinguished from other executions within the collection by a global ID and a local ID. A subset of work-items in a workgroup that execute simultaneously together on a compute unit can be referred to as a wavefront, warp, or vector. The width of a wavefront is a characteristic of the hardware of the compute unit. As used herein, the term “compute unit” is defined as a collection of processing elements (e.g., single-instruction, multiple-data (SIMD) units) that perform synchronous execution of a plurality of work-items. The number of processing elements per compute unit can vary from implementation to implementation. A “compute unit” can also include a local data store and any number of other execution units such as a vector memory unit, a scalar unit, a branch unit, and so on. Also, as used herein, a collection of wavefronts are referred to as a “workgroup”.

During certain types of applications (e.g., ray-tracing applications) executed on a parallel processor, there is often a need to maintain a data structure, (e.g., a stack) for storing data. As used herein, a “stack” is defined as a data structure managed in a last-in, first-out (LIFO) manner. Typically, for an N-lane compute unit, all N lanes within a wavefront will push the same datum onto the stack early on in the traversal. This is a wasteful operation since the hardware will reserve space for all N entries and write all of the duplicates to the stack.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 is a block diagram of another implementation of a computing system.

FIG. 3 is a block diagram of one implementation of a compute unit.

FIG. 4 is a block diagram of one implementation of a SIMD unit.

FIG. 5 is a block diagram of one implementation of a SIMD unit.

FIG. 6 is a block diagram of one implementation of a coalescing unit.

FIG. 7 is a generalized flow diagram illustrating one implementation of a method for detecting compressibility of data writes by a wavefront.

FIG. 8 is a generalized flow diagram illustrating one implementation of a method for decompressing compressed data and distributing the decompressed data to multiple execution units.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Various systems, apparatuses, and methods for reusing an address coalescence unit for deduplicating data are disclosed herein. In one implementation, a parallel processor includes at least a plurality of compute units for executing wavefronts of a given application. The given application can be any of various types of applications, such as a rendering application for processing texture data and other graphics data. Each compute unit includes multiple single-instruction, multiple-data (SIMD) units. When the work-items executing on the execution lanes of a SIMD unit are writing data values to a stack, many of the data values are repeated values. In these cases, when the lanes are pushing duplicate data values to the stack, a control unit converts the multi-lane push into two write operations. The first write operation is a fixed-size control word pushed onto the stack followed by a second write operation of a variable-sized data payload pushed onto the stack. The control word specifies a size of the variable-sized payload and how the variable-sized payload is mapped to the lanes. On a pop from the stack, the payload is partitioned and distributed back to the lanes based on the mapping specified by the control word. It is noted that while the present discussion generally refers to the use of a stack for storing data, other data structures are possible and are contemplated. More generally, stores to any memory or device capable of storing data are contemplated. For example, queues, trees, tables or other structures in a memory are possible.

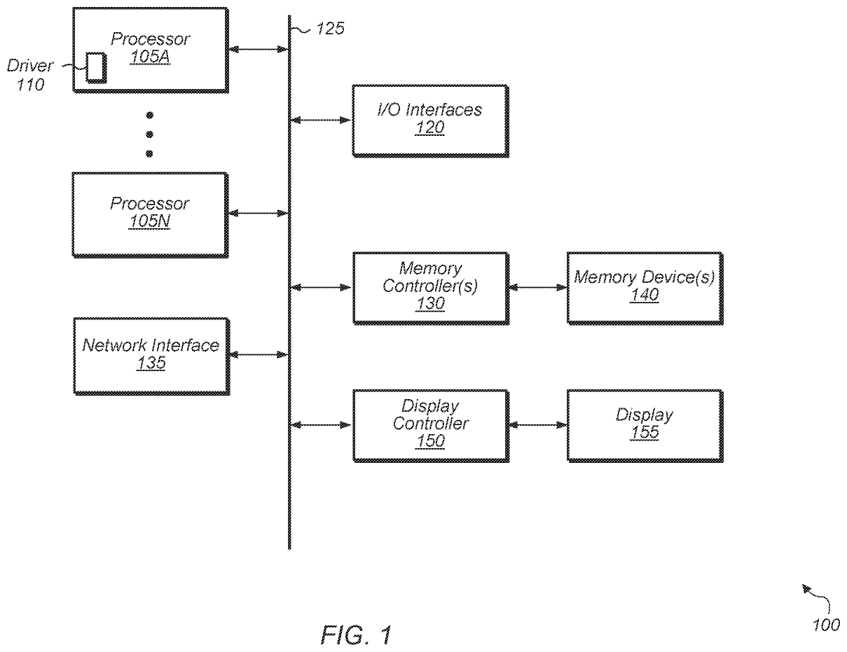

Referring now to FIG. 1, a block diagram of one implementation of a computing system 100 is shown. In one implementation, computing system 100 includes at least processors 105A-N, input/output (I/O) interfaces 120, bus 125, memory controller(s) 130, network interface 135, memory device(s) 140, display controller 150, and display 155. In other implementations, computing system 100 includes other components and/or computing system 100 is arranged differently. Processors 105A-N are representative of any number of processors which are included in system 100.

In one implementation, processor 105A is a general purpose processor, such as a central processing unit (CPU). In this implementation, processor 105A executes a driver 110 (e.g., graphics driver) for communicating with and/or controlling the operation of one or more of the other processors in system 100. It is noted that depending on the implementation, driver 110 can be implemented using any suitable combination of hardware, software, and/or firmware. In one implementation, processor 105N is a data parallel processor with a highly parallel architecture, such as a graphics processing unit (GPU) which provides pixels to display controller 150 to be driven to display 155.

A GPU is a complex integrated circuit that performs graphics-processing tasks. For example, a GPU executes graphics-processing tasks required by an end-user application, such as a video-game application. GPUs are also increasingly being used to perform other tasks which are unrelated to graphics. The GPU can be a discrete device or can be included in the same device as another processor, such as a CPU. Other data parallel processors that can be included in system 100 include digital signal processors (DSPs), field programmable gate arrays (FPGAs), application specific integrated circuits (ASICs), and so forth. In some implementations, processors 105A-N include multiple data parallel processors.

Memory controller(s) 130 are representative of any number and type of memory controllers accessible by processors 105A-N. While memory controller(s) 130 are shown as being separate from processors 105A-N, it should be understood that this merely represents one possible implementation. In other implementations, a memory controller 130 can be embedded within one or more of processors 105A-N and/or a memory controller 130 can be located on the same semiconductor die as one or more of processors 105A-N. Memory controller(s) 130 are coupled to any number and type of memory devices(s) 140. Memory device(s) 140 are representative of any number and type of memory devices. For example, the type of memory in memory device(s) 140 includes Dynamic Random Access Memory (DRAM), Static Random Access Memory (SRAM), NAND Flash memory, NOR flash memory, Ferroelectric Random Access Memory (FeRAM), or others.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, and so forth. Network interface 135 is able to receive and send network messages across a network.

In various implementations, computing system 100 is a computer, laptop, mobile device, game console, server, streaming device, wearable device, or any of various other types of computing systems or devices. It is noted that the number of components of computing system 100 varies from implementation to implementation. For example, in other implementations, there are more or fewer of each component than the number shown in FIG. 1. It is also noted that in other implementations, computing system 100 includes other components not shown in FIG. 1. Additionally, in other implementations, computing system 100 is structured in other ways than shown in FIG. 1.

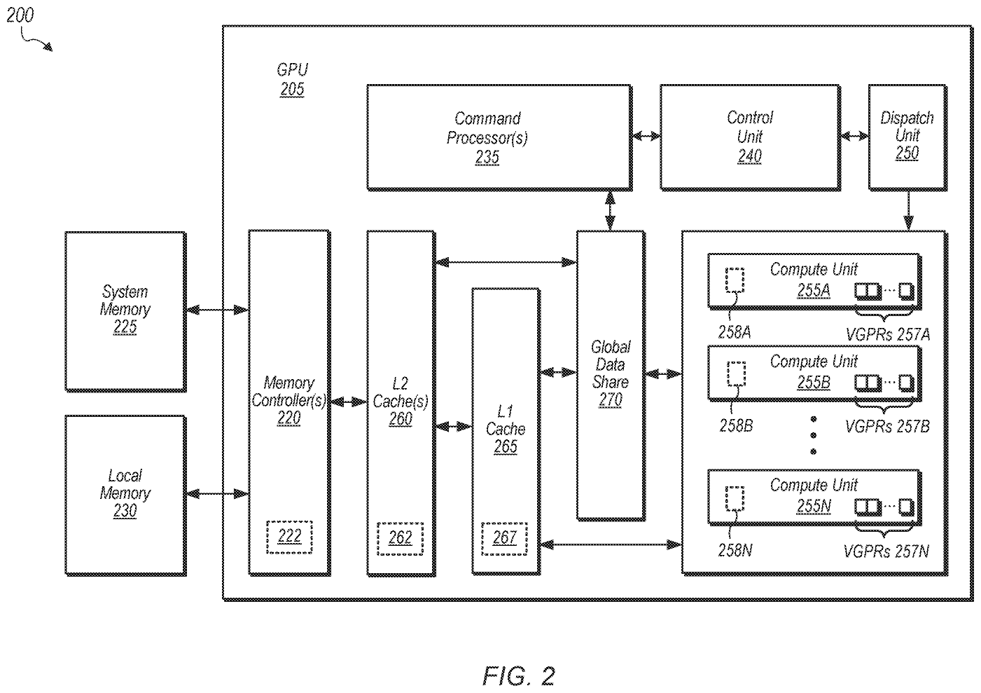

Turning now to FIG. 2, a block diagram of another implementation of a computing system 200 is shown. In one implementation, system 200 includes GPU 205, system memory 225, and local memory 230. System 200 can also include other components which are not shown to avoid obscuring the figure. GPU 205 includes at least command processor 235, control unit 240, dispatch unit 250, compute units 255A-N, memory controller(s) 220, global data share 270, level one (L1) cache 265, and level two (L2) cache(s) 260. In other implementations, GPU 205 includes other components, omits one or more of the illustrated components, has multiple instances of a component even if only one instance is shown in FIG. 2, and/or is organized in other suitable manners. In one implementation, the circuitry of GPU 205 is included in processor 105N (of FIG. 1).

In various implementations, computing system 200 executes any of various types of software applications. As part of executing a given software application, a host CPU (not shown) of computing system 200 launches work to be performed on GPU 205. In one implementation, command processor 235 receives kernels from the host CPU, and command processor 235 uses dispatch unit 250 to issue corresponding wavefronts to compute units 255A-N. Wavefronts executing on compute units 255A-N can access vector general purpose registers (VGPRs) 257A-N located on compute units 255A-N. It is noted that VGPRs 257A-N are representative of any number of VGPRs.

In one implementation, each compute unit 255A-N includes coalescing circuitry 258A-N for compressing duplicate data values that are generated by the different wavefronts executing on compute units 255A-N. For example, in one implementation, a wavefront launched on a given compute unit 255A-N includes a plurality of work-items executing on the single-instruction, multiple-data (SIMD) units of the given compute unit 255A-N. When multiple work-items are writing the same data value to a stack, this is a wasteful operation. Accordingly, a compressor (e.g., coalescing circuitry 258A-N, optional coalescing units 222, 262, 267) deduplicates the multiple data values by causing the common data value to be written to the stack only once. In one implementation, a coalescing unit compares the data values being written and identifies duplicates. In addition, the processing lanes associated with the data values are identified. Duplicate values are then eliminated and only a single instance of the duplicated values is written. A control word is then generated that maps the written data values to corresponding lanes. This helps to reduce the amount of data stored on the stack and reduces unnecessary write operations when the common data value is stored by multiple work-items executing on a compute unit 255A-N.

In one implementation, the memory write path includes coalescing hardware (e.g., coalescing circuitry 258A-N, optional coalescing units 222, 262, 267) for the detection of conflicts, address collisions, or SIMD scan primitives. Depending on the implementation, the coalescing hardware can include a single unit or multiple units. The unit(s) can be located at any of the locations shown in FIG. 2 or in other suitable locations within system 200. This coalescing hardware is reused to detect when multiple work-items are storing the same data value to a data structure. This results in area savings by reusing the same hardware to perform multiple different functions.

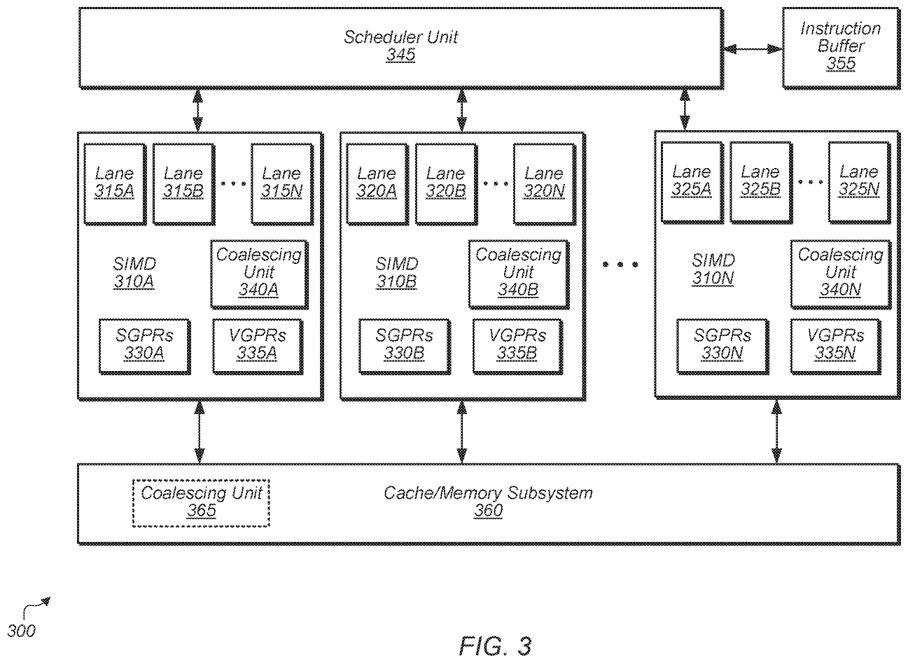

Referring now to FIG. 3, a block diagram of one implementation of a compute unit 300 is shown. In one implementation, compute unit 300 includes at least SIMDs 310A-N, scheduler unit 345, instruction buffer 355, and cache/memory subsystem 360. It is noted that compute unit 300 can also include other components which are not shown in FIG. 3 to avoid obscuring the figure.

When a data-parallel kernel is executed by the system, work-items (i.e., threads) of the kernel executing the same instructions are grouped into a fixed sized batch called a wavefront to execute on compute unit 300. Multiple wavefronts can execute concurrently on compute unit 300. The instructions of the work-items of the wavefronts are stored in instruction buffer 355 and scheduled for execution on SIMDs 310A-N by scheduler unit 345. When the wavefronts are scheduled for execution on SIMDs 310A-N, corresponding work-items execute on the individual lanes 315A-N, 320A-N, and 325A-N in SIMDs 310A-N. Each lane 315A-N, 320A-N, and 325A-N of SIMDs 310A-N can also be referred to as an “execution unit” or an “execution lane”.

In one implementation, compute unit 300 receives a plurality of instructions for a wavefront with a number N of work-items, where N is a positive integer which varies from processor to processor. When work-items execute on SIMDs 310A-N, the instructions executed by work-items can include store and load operations to/from scalar general purpose registers (SGPRs) 330A-N, VGPRs 335A-N, and cache/memory subsystem 360. For certain types of applications, all of the work-items of a given wavefront executing on the lanes of a SIMD 310A-N will store a common data value to a stack. The stack can be located in any location within SGPRs 330A-N, VGPRs 335A-N, and cache/memory subsystem 360. Also, coalescing units 340A-N and optional coalescing unit 365 in cache/memory subsystem 360 are representative of any number of coalescing units which can be located in any suitable location within compute unit 300.

For example, in a ray-tracing application, at least a portion of the work-items of a wavefront will push the same data value onto the stack early on in the traversal. In cases where a common data value is pushed onto the stack by multiple work-items executing on multiple lanes, a corresponding coalescing unit 340A-N will deduplicate the data generated by the multiple work-items. Accordingly, the coalescing unit 340A-N will cause only a single data value to be pushed onto the stack rather than multiple copies of the single data value. Also, there may be significant points in time when not all lanes are active and these inactive lanes can also be collapsed away by coalescing units 340A-N.

In one implementation, a coalescing unit 340A-N causes the following push function to be executed by compute unit 300:

v_stack_push out_address:SGPR, in_value: VGPR, in_address:SGPR

The function “v_stack_push” pushes the in_value in a VGPR to a stack located at in_address and returns the new stack address as out_address.

In one implementation, the following pop function is executed by compute unit 300:

v_stack_pop out_address:SGPR, out_value: VGPR, in_address:SGPR

The function “v_stack_pop” pops from the stack located at in_address, returns the new stack address in out_address, and writes the value for this lane in out_value.

It is noted that the above push and pop functions are merely representative of functions that can be employed in one implementation. In other implementations, other variations of push and pop functions can be employed. It is also noted that the letter “N” when displayed herein next to various structures is meant to generically indicate any number of elements for that structure (e.g., any number of SIMDs 310A-N). Additionally, different references within FIG. 3 that use the letter “N” (e.g., SIMDs 310A-N and lanes 315A-N) are not intended to indicate that equal numbers of the different elements are provided (e.g., the number of SIMDs 310A-N can differ from the number of lanes 315A-N).

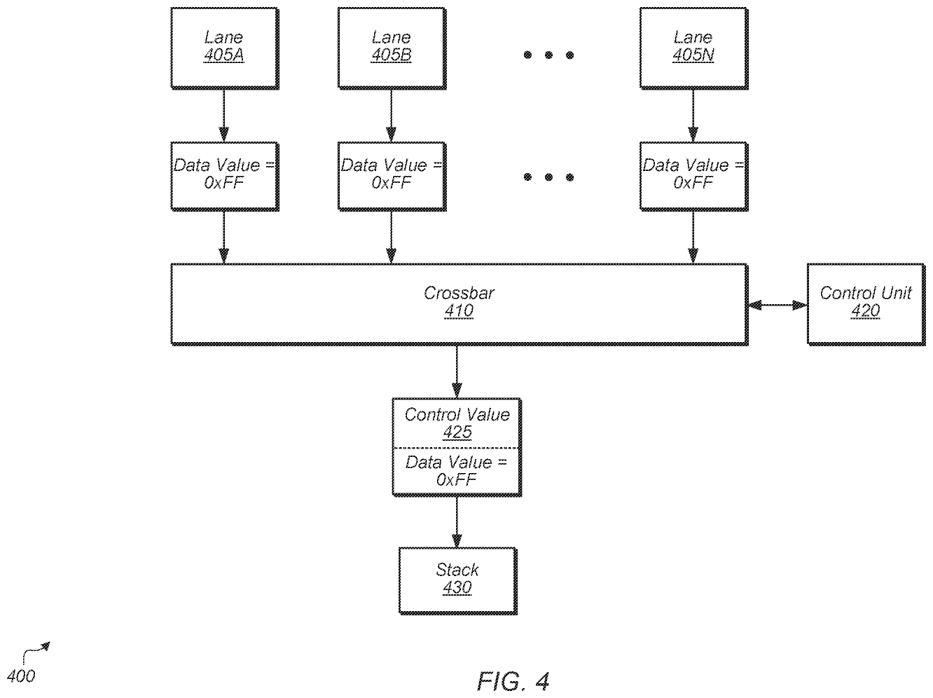

Turning now to FIG. 4, a block diagram of one implementation of a SIMD unit 400 is shown. In one implementation, SIMD unit 400 includes execution lanes 405A-N, crossbar 410, coalescing unit 420, and stack 430. Crossbar 410 is representative of any type of communication interface or circuit for connecting lanes 405A-N to the storage elements of stack 430. It is noted that stack 430 can be allocated in any suitable locations in registers, cache, or memory. It is also noted that SIMD unit 400 can include any number of other components which are not shown to avoid obscuring the figure. In one implementation, the SIMD units 310A-N of compute unit 300 includes the components of SIMD unit 400.

As shown in FIG. 4, lanes 405A-N are generating the same data value 0xFF which is to be written to stack 430. If space is reserved in stack 430 for storing all of the separate copies of data value 0xFF, this would be an inefficient use of stack 430. Accordingly, in one implementation, coalescing unit 420 detects the generation of the common data value 0xFF and performs a deduplication operation. It is noted that coalescing unit 420 can also detect cases when a subset of lanes 405A-N are writing the same data value to stack 430. Accordingly, the deduplication operation can be performed when two or more lanes 405A-N are writing a common value to stack 430.

As a result of detecting the common data value 0xFF traversing the crossbar 410, coalescing unit 420 causes only a single instance of data value 0xFF to be written to stack 430 as well as control value 425 which indicates how the original data was compressed. This reduces the storage capacity required to store the data written by lanes 405A-N as well as reducing the number of write operations that are performed. Reducing the number of write operations that are performed lowers the overall power consumption of SIMD unit 400. It is noted that coalescing unit 420 can be implemented using any suitable combination of hardware and/or program instructions. Also, depending on the implementation, coalescing unit 420 can be a single unit or coalescing unit 420 can be partitioned into multiple separate units which are situated in multiple locations within SIMD 400.

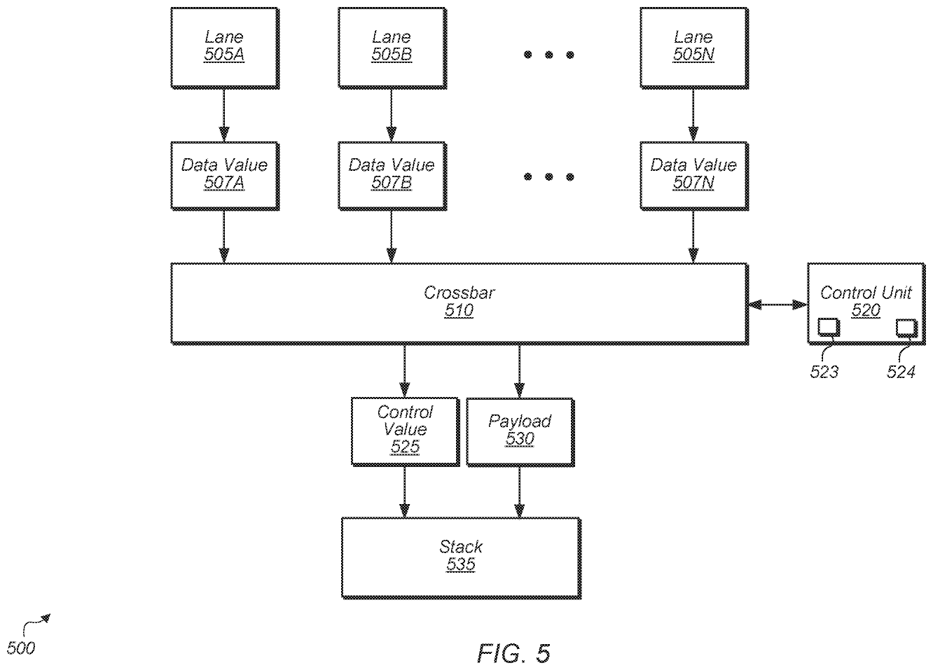

Referring now to FIG. 5, a block diagram of one implementation of a SIMD unit 500 is shown. In one implementation, coalescing unit 520 compresses data values 507A-N that are being pushed by lanes 505A-N onto stack 535. Rather than writing all data values 507A-N in an uncompressed manner to stack 535, coalescing unit 520 advantageously looks for compression opportunities in writes to stack 535 by lanes 505A-N. In one implementation, coalescing unit 520 observes the traffic traversing crossbar 510 to find opportunities for compressing data writes to stack 535.

In one implementation, coalescing unit 520 includes mapping unit 523 and payload generation unit 524. Mapping unit 523 generates control value 525 which maps data values 507A-N to payload 530 generated by payload generation unit 524. In one implementation, control value 525 includes a predetermined number of bits for each lane of lanes 505A-N. For example, in one implementation, control word bits for a lane identify which data in the corresponding payload corresponding to the lane. As an example, in an implementation with 32 lanes, the control word can have 32*6 bits=192 bits. Each of the 6 bits is then used to identify a particular data value in the payload. Payload generation unit 524 generates variable-sized payload 530 from data values 507A-N. In other words, payload generation unit 524 compresses data values 507A-N to generate variable-sized payload 530. Coalescing unit 520 causes control value 525 and payload 530 to be written to stack 535 as a representation of data values 507A-N. When control value 525 and payload 530 are later popped from stack 535, coalescing unit 520 decompresses payload 530 and returns the original data values to lanes 505A-N based on the mapping indicators stored in control value 525. In various implementations, the control word is included when there is compression and when there is not compression and a bit (or bits) can be used to indicate whether the data is compressed.

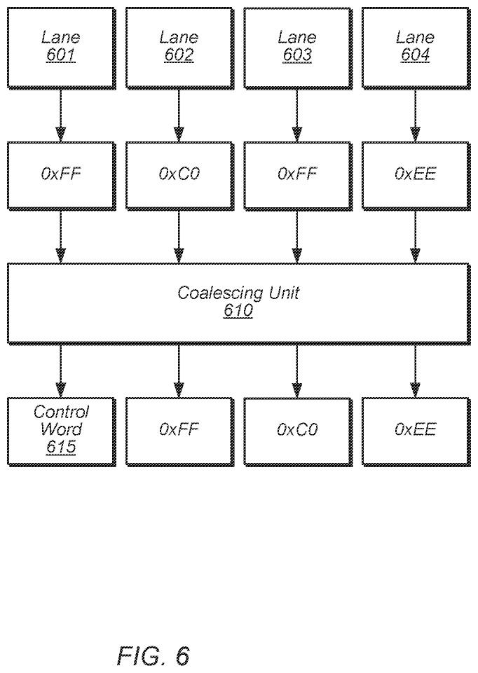

Turning now to FIG. 6, a block diagram of one implementation of a coalescing unit 610 is shown. In one implementation, coalescing unit 610 compresses the data values that are being pushed by lanes 601-604 onto a data structure (not shown). The data structure can be located in a register file, local data store, cache, memory, or other location. As shown in FIG. 6, lanes 601 is writing value “0xFF”, lane 602 is writing value “0xC0”, lane 603 is writing “0xFF”, and lane 604 is writing value “0xEE”. Since lanes 601 and 603 are writing the same data value, coalescing unit 610 is able to compress the data of this multi-lane write operation. The output that is written to the data structure is shown below coalescing unit 610 as control word 615 and data values “0xFF”, “0xC0”, and “0xEE”. Control word 615 includes an encoding which specifies how the original data is mapped to the compressed data. In general, any time a data value is duplicated across two or more lanes, coalescing unit 610 is able to compress the data being written to the data structure. It should be understood that the example of four lanes 601-604 is shown merely for illustrative purposes. In general, a coalescing unit can work to compress data across any number of lanes.

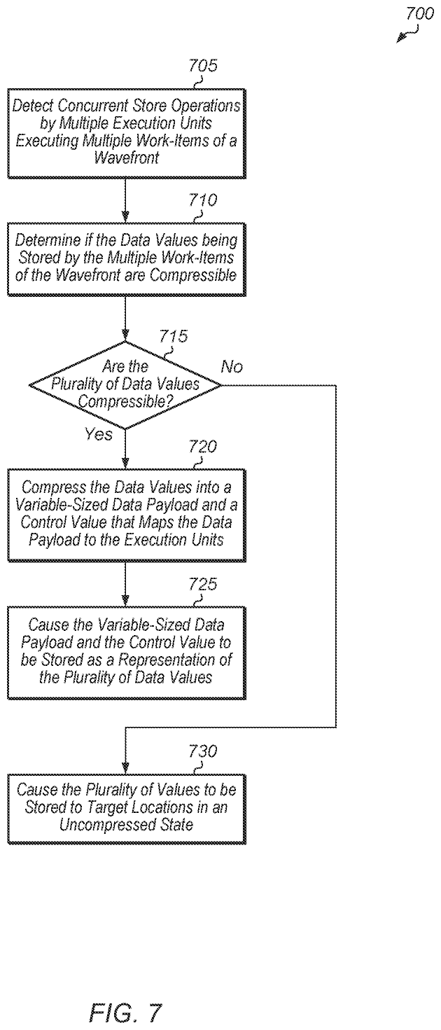

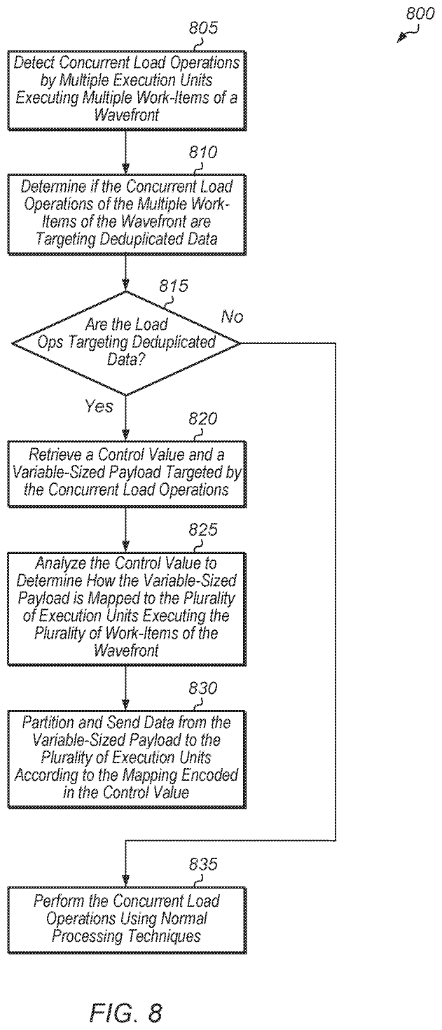

Referring now to FIG. 7, one implementation of a method 700 for detecting compressibility of data writes by a wavefront is shown. For purposes of discussion, the steps in this implementation and those of FIG. 8 are shown in sequential order. However, it is noted that in various implementations of the described methods, one or more of the elements described are performed concurrently, in a different order than shown, or are omitted entirely. Other additional elements are also performed as desired. Any of the various systems or apparatuses described herein are configured to implement method 700.

A coalescing unit detects concurrent store operations by multiple execution units (e.g., execution lanes 315A-N of FIG. 3) executing multiple work-items of a wavefront (block 705). In one implementation, the concurrent store operations are targeting a stack. In other implementations, the concurrent store operations are targeting other data structures and/or memory locations. In response to detecting the concurrent store operations, the coalescing unit determines if the data values being stored by the multiple work-items of the wavefront are compressible (block 710).

If the plurality of data values are compressible (conditional block 715, “yes” leg), then the coalescing unit compresses the data values into a variable-sized data payload and a control value that maps the data payload to the execution units (block 720). Any of various compression standards can be used to compress the data. In some cases, the same data value will be written by multiple work-items to a stack or other data structure. In these cases, the multiple occurrences of the same data value are compressed into a single copy of the data value. In other scenarios, more complex compression techniques can be used to compress the data values.

Next, the coalescing unit causes the variable-sized data payload and the control value to be stored as a representation of the plurality of data values (block 725). After block 725, method 700 ends. If the plurality of data values are not compressible (conditional block 715, “no” leg), then the coalescing unit causes the plurality of data values to be stored to target locations in an uncompressed state (block 730). After block 730, method 700 ends.

Turning now to FIG. 8, one implementation of a method 800 for decompressing compressed data and distributing the decompressed data to multiple execution units is shown. A coalescing unit detects concurrent load operations by a plurality of execution units (e.g., execution lanes 315A-N of FIG. 3) executing multiple work-items of a wavefront (block 805). In one implementation, the concurrent load operations are targeting a stack. In other implementations, the concurrent load operations are targeting other types of data structures and/or memory locations.

In response to detecting the concurrent load operations, the coalescing unit determines if the concurrent load operations of the multiple work-items of the wavefront are targeting deduplicated data (block 810). If the concurrent load operations are targeting deduplicated data (conditional block 815, “yes” leg), then the coalescing unit retrieves a control value and a variable-sized payload targeted by the concurrent load operations (block 820). Next, the coalescing unit analyzes the control value to determine how the variable-sized payload is mapped to the plurality of execution units executing the plurality of work-items of the wavefront (block 825). Then, the coalescing unit partitions and sends data from the variable-sized payload to the plurality of execution units according to the mapping encoded in the control value (block 830). After block 830, method 800 ends. If the concurrent load operations are not targeting deduplicated data (conditional block 815, “no” leg), then the concurrent load operations are performed using normal processing techniques (block 830). After block 830, method 800 ends.

In various implementations, program instructions of a software application are used to implement the methods and/or mechanisms described herein. For example, program instructions executable by a general or special purpose processor are contemplated. In various implementations, such program instructions are represented by a high level programming language. In other implementations, the program instructions are compiled from a high level programming language to a binary, intermediate, or other form. Alternatively, program instructions are written that describe the behavior or design of hardware. Such program instructions are represented by a high-level programming language, such as C. Alternatively, a hardware design language (HDL) such as Verilog is used. In various implementations, the program instructions are stored on any of a variety of non-transitory computer readable storage mediums. The storage medium is accessible by a computing system during use to provide the program instructions to the computing system for program execution. Generally speaking, such a computing system includes at least one or more memories and one or more processors configured to execute program instructions.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. An apparatus comprising:
a plurality of execution units; and
a coalescing unit, wherein responsive to detecting a repeated data value among a plurality of store operations of the plurality of execution units, the coalescing unit is configured to:
generate a control value and a deduplicated data payload, wherein the control value maps a plurality of data values in the deduplicated data payload to the execution units; and
cause the control value and the data payload to be written to a memory.

2. The apparatus as recited in claim 1, wherein the plurality of store operations are performed by a plurality of work-items of a wavefront executing on the plurality of execution units.

3. The apparatus as recited in claim 1, wherein the control value maps repeated data values to multiple execution units of the plurality of execution units.

4. The apparatus as recited in claim 1, wherein the coalescing unit is further configured to:
detect a plurality of load operations targeting the plurality of data values;
retrieve the control value and the data payload; and
partition and send the data payload to multiple execution units based on a mapping encoded into the control value.

5. The apparatus as recited in claim 4, wherein the coalescing unit is further configured to send the repeated data value to two or more execution units of the plurality of execution units, wherein the two or more execution units are identified by the control value.

6. The apparatus as recited in claim 1, wherein the data payload is variable-sized.

7. The apparatus as recited in claim 6, wherein a size of the variable-sized data payload is specified by the control value.

8. A method comprising:
detecting, by a coalescing unit, a repeated data value among a plurality of store operations of a plurality of execution units;
responsive to detecting the repeated data value among the plurality of store operations of the plurality of execution units, generating a control value and a deduplicated data payload, wherein the control value maps a plurality of data values in the deduplicated data payload to the execution units; and
causing the control value and the data payload to be written to a memory.

9. The method as recited in claim 8, wherein the plurality of store operations are performed by a plurality of work-items of a wavefront executing on the plurality of execution units.

10. The method as recited in claim 8, wherein the control value maps repeated data values to multiple execution units of the plurality of execution units.

11. The method as recited in claim 8, further comprising:
detecting a plurality of load operations targeting the plurality of data values;
retrieving the control value and the data payload; and
partitioning and sending the data payload to multiple execution units based on a mapping encoded into the control value.

12. The method as recited in claim 11, further comprising sending the repeated data value to two or more execution units of the plurality of execution units, wherein the two or more execution units are identified by the control value.

13. The method as recited in claim 8, wherein the data payload is variable-sized.

14. The method as recited in claim 13, wherein a size of the variable-sized data payload is specified by the control value.

15. A system comprising:
a memory; and
a processor coupled to the memory, wherein responsive to detecting a repeated data value among a plurality of store operations of a plurality of execution units, the processor is configured to:
generate a control value and a deduplicated data payload, wherein the control value maps a plurality of data values in the deduplicated data payload to the execution units; and
cause the control value and the data payload to be written to a memory.

16. The system as recited in claim 15, wherein the plurality of store operations are performed by a plurality of work-items of a wavefront executing on a plurality of execution units.

17. The system as recited in claim 15, wherein the control value maps repeated data values to multiple execution units of the plurality of execution units.

18. The system as recited in claim 15, wherein the processor is further configured to:
detect a plurality of load operations targeting the plurality of data values;
retrieve the control value and the data payload; and partition and send the data payload to multiple execution units based on a mapping encoded into the control value.

19. The system as recited in claim 18, wherein the processor is further configured to send the repeated data value to two or more execution units of the plurality of execution units, wherein the two or more execution units are identified by the control value.

20. The system as recited in claim 15, wherein the data payload is variable-sized, and wherein a size of the variable-sized data payload is specified by the control value.
